(19) United States
(12) Patent Application Publication
(10) Pub. No.: US 2002/0173974 A1
(43) Pub. Date: Nov. 21, 2002

(54) Quality enhancement of patent acquisition management

(76) Inventor: William Kendall Meade II, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/858,835

(22) Filed: May 15, 2001

(51) Int. Cl. G06F 17/60

(52) U.S. Cl. 705/1

(57) ABSTRACT

An implementation of a technology, described herein, for managing the preparation and prosecution of patent applications and quality management of the same. This technology acts as a catalyst or facilitator for the patrons of a service using such technology. It can handle some or all of the functions related patent acquisition, and enhance the quality of the resulting patents. Such functions may include invention disclosure gathering; encouraging invention disclosure; patent application drafting, filing, prosecution, and handling issuance and maintenance fees; and managing all of the above. It facilitates quality enhancement of resulting patents by encouraging more invention disclosures by providing a reliable, automated mechanism for rewards such action and by providing information (related to potential interferences) that helps patrons may good business decisions early in the patenting process to same time and money. It does some or all of these functions while maintaining a privileged double-blind information flow. This abstract itself is not intended to limit the scope of this patent. The scope of the present invention is pointed out in the appending claims.

### TECHNICAL FIELD

This invention generally relates to a technology for managing the preparation and prosecution of patent applications and quality management of the same.

### BACKGROUND

The practice of patent acquisition includes preparation and prosecution of patent applications. The preparation and prosecution of patent applications is also called “prep-n-pros,” for short.

Typically, a patent application is drafted on an invention. It is filed with a patent office. It is prosecuted with the patent office. Hopefully, a patent ultimately issues from the application filed.

Patent Application Preparation

Preparation of patent applications is typically performed by a patent attorney, patent agent, paralegal, or other patent (or legal) personnel. Preparation typically includes some or all of the following tasks for a given invention:

preparing initial invention disclosure that document a potential invention;

analyzing the invention disclosure to determine if this one is a good candidate for the patent application process;

conducting an in-depth review of the invention, if necessary;

performing a search for prior art;

drafting a patent application on the candidate inventions;

review of drafts of such applications; and

filing the final authorized draft of the patent application (with necessary signed documents).

Those of ordinary skill in the art are familiar with the preparation and filing of patent applications.

Patent Application Prosecution

The filing of a patent application and correspondence with a patent office (such as the U.S. Patent and Trademark Office (USPTO)) to obtain a patent is commonly referred to as “patent application prosecution” or simply “patent prosecution.” Patent prosecution begins with the drafting and filing of a patent application.

The prosecution typically involves a series of exchanges with the patent office. It is extremely common for the application to be rejected for substance and/or form. The series of exchanges acts as a negotiation where boundaries of patent protections are determined. In addition, patent application prosecution includes handling issuance and maintenance fees.

Those of ordinary skill in the art are familiar with the prosecution of patent applications.

Patent Acquisition Practice

The line between preparation and prosecution is vague. However, collectively preparation and prosecution is called “prep-and-pros” or “patent acquisition.” The patent acquisition practice is the practice of acquiring patents. In other words, the practice of preparing and prosecuting patent applications for the purpose of ultimately acquiring patents.

Patent Interference Practice

In the U.S., a patent interference is a form of quasi-litigation before the U.S. Patent and Trademark Office (USPTO). It is an antedating proceeding for determining who is the prior inventor of the same invention (i.e., who should be awarded priority). An interference can be declared between two (or more) pending patent applications claiming the same invention or between an issued patent and one (or more) pending applications claiming the same invention.

Patent interference is defined in the law. Specifically, in the following patent laws, rules, and regulations:

patent statutes, including 35 U.S.C., and in section 135 in particular;

patent rules, including 37 C.F.R., and in section 1.601-1.690 in particular;

patent procedures, including the M.P.E.P., and in chapter 2300 in particular.

Since patent applications are unavailable to the public, an inventor has no way of knowing whether her invention is already covered by a pending application. Moreover, there yet-to-be-filed applications for inventions that were invented prior to our inventor's invention. If our inventor knew of a potential conflict with a pending application or unfilled application, the inventor could save time and money by ending her pursuit of a patent or by redirecting the claims to a different patentable feature of the invention.

Accordingly, what is needed is a patent acquisition management system that enhances the quality of the patents resulting from the system. Quality, in this sense, is a measure of a patent's relative strength when compared to the prior art and its breadth of coverage. What is also needed is a system that can handle the patent acquisition process from beginning to end. What is needed is a system that can encourage employees to disclose inventions by effectively and automatically rewarding them from doing so.

Moreover, what is needed is a system that can help business avoid the cost (in time and money) of pursuing patent protection for an invention that is the subject of pending application and, better yet, that is subject of a yet-to-be-filed application for an invention that has was invented previously.

### SUMMARY

Described herein is a technology for managing the preparation and prosecution of patent applications and quality management of the same. This technology acts as a catalyst or facilitator for the patrons of a service using such technology. It can handle some or all of the functions related patent acquisition, and enhance the quality of the resulting patents. Such functions may include invention disclosure gathering; encouraging invention disclosure; patent application drafting, filing, prosecution, and handling issuance and maintenance fees; and managing all of the above. It facilitates quality enhancement of resulting patents by encouraging more invention disclosures by providing a reliable, automated mechanism for rewards such action and by providing information (related to potential interferences) that helps patrons may good business decisions early in the patenting process to same time and money. It does some or all of these functions while maintaining a privileged double-blind information flow.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a schematic block diagram showing a patent-acquisition architecture in accordance with an implementation of the invention claimed herein.

FIG. 2 is a flow diagram showing a methodological implementation of the invention claimed herein.

FIG. 3 is a flow diagram showing a methodological implementation of the invention claimed herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well known features are omitted or simplified to clarify the description of the exemplary implementations of present invention, thereby better explain the present invention. Furthermore, for ease of understanding, certain method steps are delineated as separate steps; however, these separately delineated steps should not be construed as necessarily order dependent in their performance.

The following description sets forth one or more exemplary implementations of a quality enhancement of patent acquisition management that incorporate elements recited in the appended claims. These implementations are described with specificity in order to meet statutory written description, enablement, and best-mode requirements. However, the description itself is not intended to limit the scope of this patent.

The inventor intends these exemplary implementations to be examples. The inventor does not intend these exemplary implementations to limit the scope of the claimed present invention. Rather, the inventor has contemplated that the claimed present invention might also be embodied and implemented in other ways, in conjunction with other present or future technologies.

An example of an embodiment of a quality enhancement of patent acquisition management may be referred to as an “exemplary patent-quality management.”

Introduction

The one or more exemplary implementations, described herein, of the present claimed invention may be implemented (in whole or in part) by a patent-quality management architecture 100 and/or by a computing environment.

In general, the exemplary patent-quality management handles some portion or all of the preparation and prosecution of patent applications for a collection of inventions (or potential inventions) and manages the quality of the same. The preparation and prosecution of patent applications may also be called “prep-npros,” for short.

Patent-Quality Management Architecture

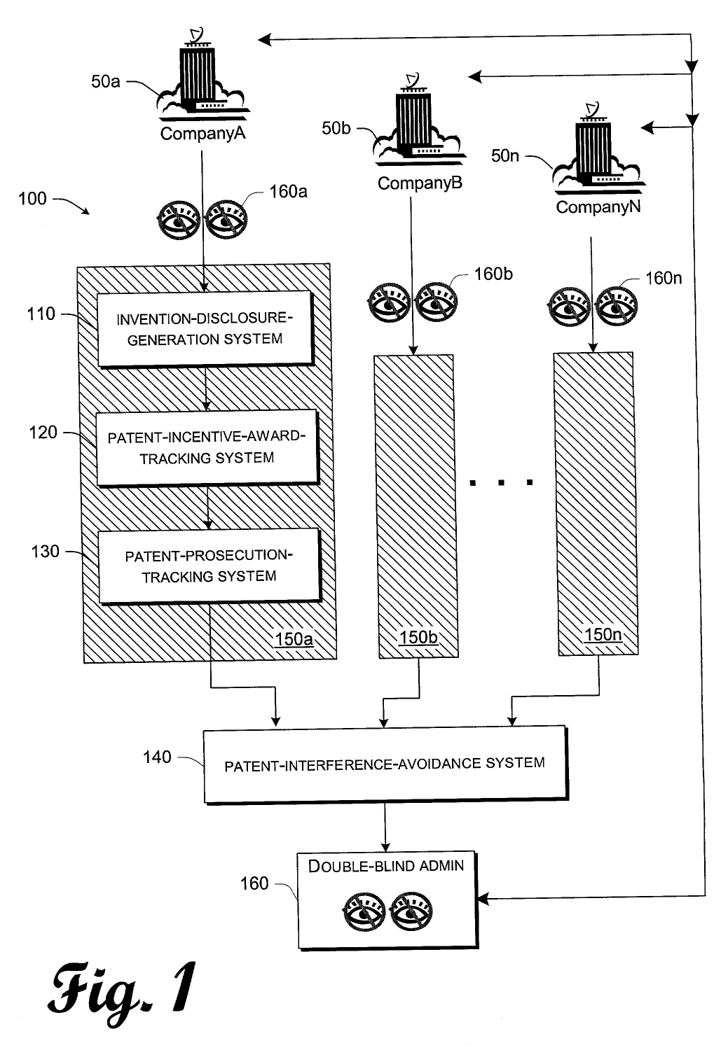

As shown in FIG. 1, the patent-quality management architecture 100 includes the following systems:

invention-disclosure-generation system 110;

patent-incentive-award-tracking system 120;

patent-prosecution-tracking system 130;

patent-interference-avoidance system 140.

Implementations of the patent-quality management architecture 100 may employ all of these systems and it may include multiple versions of each system, where each version is associated with a particular business (or patron). Alternatively, implementations may employ some combination of these systems or perhaps just one of the systems. Other alternative implementations may employ only a portion of one system. The implementations of the patent-quality management architecture 100 also include an aspect of the double-blind administration 160 (and 160a-160n).

FIG. 1 shows that the patent-quality management architecture 100 includes the four systems (110-140) and the double-blind administration 160. It includes multiple sub-architectures 150a-150n. A sub-architecture includes invention-disclosure-generation system 110, patent-incentive-award-tracking system 120, and patent-prosecution-tracking system 130. In addition, each is fronted by a double-blind administration (e.g., 160a-160n, respectively). Alternatively, the double-blind administration may be situated at the backend of each sub-architecture. In other words, it may be between the sub-architectures and the patent-interference-avoidance system 140.

Each of the sub-architectures is associated with a single business entity. The functions performed within a sub-architecture does not compare inventions from different business entities. For example, sub-architecture 150a is associated with CompanyA 50a; sub-architecture 150b is associated with CompanyB 50b; and sub-architecture 150n is associated with CompanyN 50n. These business entities may also be called the patrons, customers, subscribers, and the like for the company providing the services of the patent-quality management via the patent-quality management architecture 100.

The patent-interference-avoidance system 140 is not part of the sub-architectures because it compares the inventions of multiple patrons to determine whether there is a potential for interference. By its nature, a patron cannot interfere with itself (assuming that it actually owns the rights it purports to).

However, an “intraference” may exist within a patron. In that way, a patron may intrafere with itself. A double-blind process, as described herein, may detect an intraference amongst the claims of different patent and patent applications owned by a common patron.

Herein, the concept of interference expressly include “intraference.” Of course, the specific context may make it clear that interference does not include “intraference.”

Consequently, the patent-interference-avoidance system 140 may include a subsystem that is part of the multiple sub-architectures 150a-150n. This may be called a patent-intraference-avoidance subsystem (not shown in FIG. 1).

The information flowing into and out of the architecture 100 (or alternatively just through the patent-interference-avoidance system 140) is filtered through a double-blind administration 160 (and 160a-160n). This insulates the architecture (or a portion thereof) from bias and conflicts-of-interest. See the section titled “Privileged Double-Blind Information Flow” for more details on this terminology. The double-blind administration 160 may also be called patron-identity-obfuscation system.

The directional arrows of FIG. 1 are intended to give an overall impression of the general data flow through the systems. However, the flow has flexibility within it. It is not fixed. The functions of the patent-interference-avoidance system 140 are not dependent upon the completion of the functions of any of the other systems 110-130, except that inventions must be disclosed in some fashion. Therefore, the functions of the patent-interference-avoidance system 140 may be performed after and/or concurrently with other systems.

In general, the patent-quality management architecture 100 may be employed by one business entity to enhance the quality of its own patents (and inventions). Moreover, it also may be employed by several entitles (as shown in FIG. 1) as a service provided by a patent-quality management team.

Patrons of such a service may contract for the service from a patent-quality management entity. The service performs some, many, or all of the functions of the invention-disclosure-generation system 110, patent-incentive-award-tracking system 120, patent-prosecution-tracking system 130, and/or patent-interference-avoidance system 140. Such a patent-quality management entity earns a profit by charging for these services.

Privileged Double-Blind Information Flow

The actions of the exemplary patent-quality management are double-blind. This includes some, many, or all of the functions of the invention-disclosure-generation system 110, patent-incentive-award-tracking system 120, patent-prosecution-tracking system 130, and/or patent-interference-avoidance system 140.

In a laboratory-sense, “double-blind” is a testing procedure, designed to eliminate biased results, in which the identity of those receiving a test treatment is concealed from both administrators and subjects until after the study is completed.

In the context of the description of the exemplary patent-quality management, “double-blind” means that the identity of the patrons is concealed from those providing services related to the inventions. Examples of such services include searching for prior art and determining whether there is a potential for interference. This not only eliminates bias, but it also eliminates likely conflicts of interests (and ethical conflicts) for the lawyers involved in performing or overseeing such services.

In addition to being double-blind, the information flow is also privileged so that only limited information regarding other's inventions is revealed. For example, it may be revealed that the patent-quality management service is aware of a pending application that may have a potential for a future interference proceedings. The identity of the other patron is not revealed. The identity and content of the pending application is not revealed.

The exemplary patent-quality management employs a privileged double-blind flow of information between the patrons and the patent-quality management team. The people, machinery, and computers performing the actual substantive work for a patron are unaware of the identity of that patron. Therefore, the work, analysis, and opinion of not biased. There is no conflict of interest that usually occurs when a patent attorney represents more than one client developing technology in a similar arena.

The double-blind administration 160, 160a-n, provides the necessary filtering function to insulate the architecture 100 (or some of the systems therein) from direct contact with the patrons and from identifying information regarding patrons.

Invention-Disclosure-Generation System

The invention-disclosure-generation system 110 is designed to efficiently facilitate the electronic capture and tracking of invention disclosures. One way to do this is via a hypermedia front-end (such as a Web page) and a database backend. Oracle is an example of product that may be used as a database back-end.

With this system, employees of a business may electronically submit an invention disclosure as soon as they conceive of the invention. That disclosure is immediately captured and electronically organized in a database of such disclosures. Such an invention-disclosure-generation system 110 may be called an “invention e-disclosure” system.

Patent-Incentive-Award-Tracking System

The patent-incentive-award-tracking system 120 uses the invention e-disclosure system. It may also be called a “patent-incentive management” system.

A patent incentive award program is common is both corporations and governments, particularly where research and development is occurring. Typically, such a program grants monetary or honorary recognition to an employee for an invention for which patent coverage is sought and/or granted. This encourages employees to inform others about their potential inventions and document them.

The patent-incentive-award-tracking system 120 is an automated system that works in conjunction with the invention-disclosure-generation system 110 to track disclosures from employees and reward them accordingly. It can also be linked to the systems having employee database records and payroll records. The rewards can be automatically calculated and distributed at any state of the patent acquisition process.

For example, the patent-incentive-award-tracking system 120 may generate a small reward (e.g., $100) to an employee for simply providing an invention disclosure. It may provide another one (e.g., $1000) upon filing of an application based upon such disclosure. It may provide still another one (e.g., $1500) when a patent is granted. It may provide still another reward to the inventors when their patent is licensed.

While the invention-disclosure-generation system 110 is an invention-harvesting tool, the patent-incentive-award-tracking system 120 is an invention-fertilizing tool that encourages the growth of new and better inventions from that already fertile soil-the employees. The exemplary patent-quality management uses these two systems together to better and more effectively manage and reap the benefit of an intelligent, well-trained, and imaginative workforce.

Patent-Prosecution-Tracking System

The patent-prosecution-tracking system 130 also uses the invention e-disclosure system. It may also be called a “patent-prosecution management” system. In general, the patent-prosecution-tracking system 130 includes the following:

searching sub-system;

patent-application-drafting sub-system;

patent-application-prosecution sub-system.

Searching Sub-System

For each subject invention, the searching sub-system searches patent and/or non-patent prior art to find references and documents describing an invention similar to the subject invention. Based upon the results of such search, it will be decided whether and how to proceed with the patent acquisition process.

Alternatively, some or all of the functions of searching sub-system may be farmed out (i.e., outsourced) to another group of professional searchers.

In either scenario, a patron of the exemplary patent-quality management will get an impartial and independent analysis of the subject invention in light of the prior art found during a search. The functions of the searching sub-system are privileged double-blind. See the section titled “Privileged Double-Blind Information Flow” for more details on this terminology.

Those associated with a patent application have a duty to disclose all known information material to patentability, but they do not have a duty to search for such information. As a result, many businesses adopt an “ignorance-is-bliss” policy for patent acquisition. According to this policy, searching is limited or eliminated so that there is no need to disclose any information material to patentability because none is known. This policy relies on the patent office to uncover relevant prior art.

The consequence of this policy is a patent acquisition strategy that is analogous to firing a shotgun in the dark. This produces so-called “garbage” patent applications. These applications would not have been filed if a thorough search was performed. However, a business may not know that an application is garbage until a great deal of time and money is spent pursuing its patentability. With the searching sub-system, the patent acquisition strategy is analogous to firing a rifle in a well-lit shooting range.

Patent-Application-Drafting Sub-System

For each subject invention, the patent-application-drafting sub-system prepares the patent application for filing. This includes writing one or more iterative drafts of the application and getting the necessary forms signed. Preferably, this will be performed by a highly trained patent attorney, but it may be done by a patent agent. Alternatively, a first draft of claims may be prepared by trained technical staff that are neither patent attorneys or agents.

For each subject invention, the patent-application-drafting sub-system also files the final draft of the patent application and all necessary forms associated therewith.

Patent-Application-Prosecution Sub-System

For each subject invention, the patent-application-prosecution sub-system handles the correspondence with the patent office (e.g., the U.S. Patent and Trademark Office). This is when the allowable subject matter of the claims of the patent application is determined through cooperative efforts of the patent office and representatives (e.g., those who are part of the exemplary patent-quality management) of the applicant (e.g., patrons).

Patent-Interference-Avoidance System

The patent-interference-avoidance system 140 is quite effective when the exemplary patent-quality management services a group of businesses (“patrons”) that are developing technology in common or related fields. It is also effective when the exemplary patent-quality management services a large (possibly multinational) business conduction large quantities of research and development producing patent applications from may locations and/or by many attorneys in narrow fields. This sub-system compares the inventions of the patrons, in a double-blind fashion, to do the following:

detect potential interferences (this includes intraferences);

notify patrons of such potential interferences;

resolve such potential interferences amongst patrons.

Typically, the compared inventions are compared after some or all claims are drafted. (Of course, the claims of already-issued patents may be compared too.) That way, the comparison can be more precise because the claims themselves (which are the basis for interferences) are being compared. However, the inventions may be compared at any point in the process from initial invention disclosure to drafting of claims to production of drawings to pre-filing to post-filing to pre-issuance to post-issuance. And anywhere in between.

In one implementation of exemplary patent-quality management, the patrons are provided access to the database of the patent-prosecution-tracking system 130 and in particular to the in-process claims. However, the identity of who owns which claims is hidden. A patron can examine the patent claims in the database to determine whether such claims of a likely interferences. The patron can inform the patent-quality management service about a potential conflict. The service, in turn, may pass along that information to the owner of the claims in question.

In another implementation of exemplary patent-quality management, patent attorneys, agents, engineers, paralegals, or other similar personnel review patrons' inventions. They compare the inventions. They determine whether there are any inventions that similar enough to justify provoking a patent interference. Thus, the sub-system generally determines the likelihood of a patent inferences provocation between two or more inventions-or more precisely, between the claims of two or more applications or patents derived from the inventions.

If a threshold level of interference likelihood is determined to exist between two or more inventions, the owners of the potentially interfering inventions are notified of the potential interference. This is done without revealing the identities of the owners of the potentially interfering inventions to one another. This protects the confidentially of each patron. Alternatively, the patent-interference-avoidance system 140 may notify selected patrons, in particular, the patrons less likely to prevail in an interference proceeding.

The patent-interference-avoidance system 140 may also facilitate a resolution of potential disputes between patrons with potentially interfering inventions. The sub-system may facilitate resolution by using alternative dispute resolution (ADR) techniques, such as “early neutral evaluator”; mediation; and arbitration.

The patent-interference-avoidance system 140 may provide its independent and neutral opinion of which patron is more likely to prevail based upon the standards of patent interference practice (such as those specified in the relevant statutes, rules, and procedures referenced in the Background section). This will encourage the parties to negotiate a settlement, which may include a cross-license, exchange of monies, exchange of information, and/or for one to abandon its pursuit of a patent.

Alternatively, the patent-interference-avoidance system 140 can mediate or arbitrate the issues surrounding the potential interference.

No matter which approach is used, the patent-interference-avoidance system 140 informs the parties of a potential future conflict-namely, a patent interference-that can be addressed early in the patent acquisition process before a wealth of funds and time are expended pursing a patent on an invention. Consequently, the techniques of the exemplary patent-quality management are more efficient and less expensive than conventional patent acquisition practice because it can recognize potential future conflicts and facilitate to resolve them.

Methodological Implementation of the Exemplary Patent-Quality Management

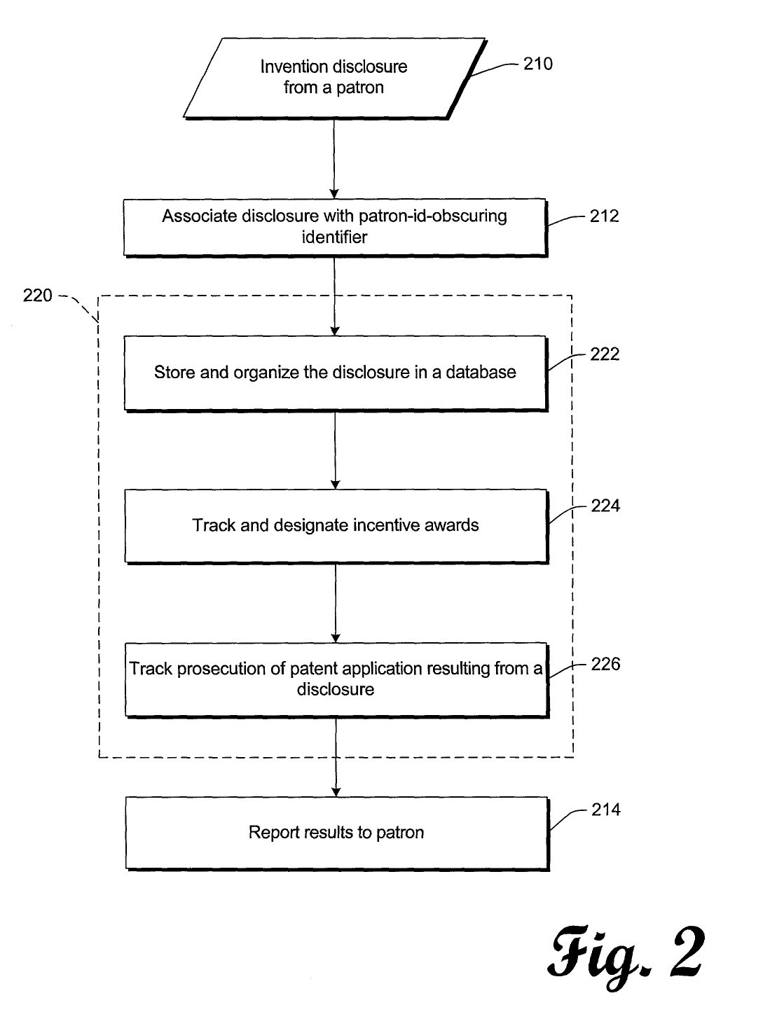

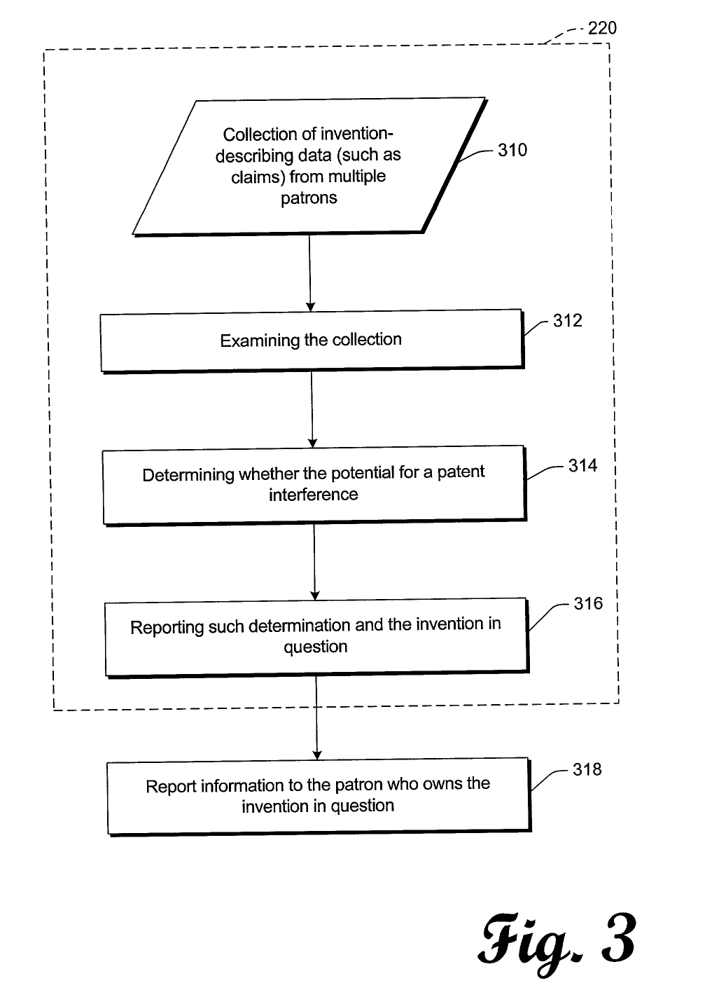

FIGS. 2 and 3 show methodological implementations of the exemplary patent-quality management performed by the patent-quality management architecture 100 (or some portion thereof). These methodological implementations may be performed in software, hardware, or a combination thereof.

FIG. 2 shows an invention disclosure from a patron at 210. At 212, that disclosure is associated with a patron-id-obscuring identifier, which will allow the double-blind administration to identify the patron but not others.

Dashed block 220 includes steps that are performed within the double-blind scheme. Alternatively, some but not all of these functions are performed double-blind.

At 222 of block 220 of FIG. 2, the disclosure is stored and organized in a database. At 224, the progress of the patent process is monitored for the disclosure and appropriate incentive awards are triggered at the appropriate points in the process. At 226, the prosecution of the patent application is tracked and monitored. For example, the claims for an invention are stored in a database as they are being drafted.

Outside of the double-blind box, status information is reported to the patron at 214. The patron is identified based upon their patron-id-obscuring identifier. However, they are identified by the double-blind administration rather then by those directly working on the substance of the invention.

FIG. 3 shows the same dashed box 220, but inside such box are the functions performed by the interference-avoidance system. A collection of invention-describing data (such as drafted claims) from multiple patrons is made available at 310.

At 312, the collection is examined. At 314, a determination is made whether there is a potential for a patent interference. At 316, that determination is reported and the invention in question is reported.

Outside of the double-blind box, status information is reported to the patron at 318. The patron is identified based upon their patron-id-obscuring identifier. However, they are identified by the double-blind administration rather then by those directly working on the substance of the invention.

Exemplary Computing Environment

The section describes an example of a suitable computing environment within which the exemplary patent-quality management may be implemented.

The exemplary patent-quality management is described as a single entity, with memory and processing capabilities, for ease of discussion. In practice, however, it may be configured (in whole or in part) as one or more computing systems that jointly or independently perform the tasks of transforming the original digital good into the protected digital good.

Providing and describing the exemplary computing environment is not intended to suggest any limitation as to the scope of use or functionality of the exemplary patent-quality management.

Generally, the computing environment includes a general-purpose (or special-purpose) computer. The components of computer may include, but are not limited to, one or more processors and a system memory. Typically, the computer is capable of using a variety of computer readable storage media. Such media may be any available media that is accessible by computer, and it includes both volatile and non-volatile media, so-called removable and so-called non-removable media.

For example, non-removable, volatile memory includes random access memory (RAM). Removeable, non-volatile memory includes read only memory (ROM) RAM typically contains data and/or program modules that are immediately accessible to and/or presently be operated on by the processor.

Examples of non-removable, non-volatile media include a so-called hard disk. Examples of removable, non-volatile media include a so-called floppy diskette and an optical disc (e.g., CD-ROM, DVD-ROM, and DVD-RAM). Hard drive may be a redundant array of disks.

These media provide storage of computer readable instructions, data structures, program modules, and other data for the computer. A number of program modules may be stored on the hard disk, magnetic disk, optical disk, ROM, or RAM, including, by way of example only, an operating system, one or more application programs, other program modules, and program data.

The computer may operate in a networked environment using logical connections to one or more remote computers, such as a remote computer. The remote computer may include many or all of the elements and features described herein relative to the computer.

The computer may be coupled to a local area network (LAN) or a general wide area network (WAN). Such networking environments are commonplace in offices, enterprise-wide computer networks, intranets, and the Internet.

Conclusion

The exemplary patent-quality management acts as a catalyst or facilitator for its patrons. It can handle all functions related patent acquisition, and enhance the quality of the resulting patents. Such functions may include invention disclosure gathering; encouraging invention disclosure; patent application drafting, filing, prosecution, and handling issuance and maintenance fees; and managing all of the above. It facilitates quality enhancement of resulting patents by encouraging more invention disclosures by providing a reliable, automated mechanism for rewards such action and by providing information (related to potential interferences) that helps patrons may good business decisions early in the patenting process to same time and money.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. An architecture for facilitating patent acquisition, the architecture comprising:
an invention-disclosure-generation system configured to store an invention disclosure in a database, such disclosure being generated based upon information provided by one or more inventors;
an incentive-award-tracking system configured to automatically determine an incentive award for the inventors based upon the invention's current patent acquisition status;
a patent-prosecution-tracking system configured to track the prosecution of the invention;
a patent-interference-avoidance system configured to facilitate a determination whether another invention may be a risk for a patent interference if a patent application for the invention is filed;
a patron-identity-obfuscation system configured to obfuscate the identity of a patron so that the patron's identity is unascertainable to at least one of the systems, except the patron-identity-obfuscation system to which the patron's identity is ascertainable, a patron being an entity seeking patent acquisition.

2. An architecture as recited in claim 1, wherein the patron-identity-obfuscation system is configured to obfuscate the identity of a patron so that the patron's identity is unascertainable to all of the systems, except the patron-identity-obfuscation system to which the patron's identity is ascertainable.

3. An architecture as recited in claim 1, wherein descriptions of the inventions are stored in a database, the database being accessible by the systems.

4. An architecture for facilitating patent acquisition, the architecture comprising:
an invention-disclosure-generation system configured to store an invention disclosure in a database, such disclosure being generated based upon information provided by one or more inventors;
an incentive-award-tracking system configured to automatically determine an incentive award for the inventors based upon the invention's current patent acquisition status;
a patent-prosecution-tracking system configured to track the prosecution of the invention;
a patron-identity-obfuscation system configured to obfuscate the identity of a patron so that the patron's identity is unascertainable to at least one of the systems, except the patron-identity-obfuscation system to which the patron's identity is ascertainable, a patron being an entity seeking patent acquisition.

5. An architecture as recited in claim 4, wherein the patron-identity-obfuscation system is configured to obfuscate the identity of the patron so that the patron's identity is unascertainable to all of the systems, except the patron-identity-obfuscation system to which the patron's identity is ascertainable.

6. An architecture as recited in claim 4 further comprising a patent-interference-avoidance system configured to facilitate a determination whether another invention may be a risk for a patent interference if a patent application for the invention is filed.

7. An architecture as recited in claim 6 wherein the a patron-identity-obfuscation system is configured to obfuscate the identity of the patron so that the patron's identity is unascertainable to the patent-interference-avoidance system.

8. An architecture as recited in claim 6 further comprising a patronidentity-obfuscation system configured to obfuscate the identity of the patron so that the patron's identity is unascertainable to all of the systems, except the patron-identity-obfuscation system.

9. An system for facilitating patent quality, the system comprising:
a database of invention records which include invention-description data, the described inventions are owned by one of multiple patrons, which are entities seeking patent acquisition;
a patent-interference-avoidance sub-system coupled to the database and configured to facilitate a determination whether a first invention may be a risk for a patent interference with a second invention.

10. A system as recited in claim 9, wherein at least one claim of the first invention a substantially similar to at least one claim of the second invention.

11. A system as recited in claim 9 further comprising a patron-identity-obfuscation system configured to obfuscate the identity of a patron so that the patron's identity is unascertainable to the patent-interference-avoidance subsystem.

12. A system as recited in claim 9, wherein a patron has no obligation to share the rights of the described inventions in the database with another patron.

13. An system for facilitating patent quality, the system comprising:
a database of invention records which include invention-description data, the described inventions are owned by at least one patron, which is entity seeking patent acquisition;
a patent-intraference-avoidance sub-system coupled to the database and configured to facilitate a determination whether a first invention may be a risk for a patent intraference with a second invention.

14. A system as recited in claim 13, wherein at least one claim of the first invention a substantially similar to at least one claim of the second invention.

15. An system for facilitating patent quality, the system comprising:
a prior-art searching sub-system coupled to the database and configured to facilitate a search of prior art based upon a description of an invention, wherein the rights of such invention is owned by a patron;
a patron-identity-obfuscation system configured to obfuscate the identity of the patron so that the patron's identity is unascertainable to the prior-art searching sub-system.

16. A computer-implemented method for facilitating patent quality, the method comprising obtaining a database containing descriptions of inventions that are publicly unavailable, where the rights of the inventions are owned by one or more multiple business entities, these business entities have no obligation to share the rights in the described inventions with another of the entities.

17. A method as recited in claim 16 further comprising providing access to the database.

18. A method as recited in claim 16, wherein described inventions are the subject of unfilled patent applications or of pending patent applications.

19. A method as recited in claim 16 further comprising determining whether a first invention may be a risk for a patent interference if a patent application for a second invention is filed, where the first or second or both inventions are a described inventions in the database.

20. A method as recited in claim 16 further comprising:
determining whether a first invention may be a risk for a patent interference if a patent application for a second invention is filed, where the first or second or both inventions are a described inventions in the database;
notifying a patron that owns the rights to the first or second invention of the results of the determining.

21. A computer-readable medium having computer-executable instructions that, when executed by a computer, performs the method as recited in claim 16.

22. A computing system comprising one or more computer-readable media having computer-executable instructions that, when executed by the computer, perform the method as recited in claim 16.

23. A computer-readable medium having stored thereon a data structure, comprising:
a first data field containing an invention disclosure;
a second data field containing patron-id-obfuscation identifier, which effectively obfuscates the identity of patrons so that the patrons' identity is unascertainable;
a third data field functioning to delimit the end of the data structure.
